(19) United States
(12) Patent Application Publication
(10) Pub. No.: US 2026/0155931 A1
(43) Pub. Date: Jun. 4, 2026

(54) UPLINK NON-COHERENCE COMPENSATION

(71) Applicant: QUALCOMM Incorporated, San Diego, CA (US)

(72) Inventors: Yi HUANG, San Diego, CA (US); Jae Ho RYU, San Diego, CA (US); Enoch Shiao-Kuang LU, San Diego, CA (US); Hyojin LEE, San Diego, CA (US); Yu ZHANG, San Diego, CA (US); Jing JIANG, San Diego, CA (US)

(21) Appl. No.: 18/968,309

(22) Filed: Dec. 4, 2024

(51) Int. Cl. H04L 5/00

(52) U.S. Cl. CPC H04L 5/0051; H04L 5/0044

(57) ABSTRACT

Various aspects of the present disclosure generally relate to wireless communication. In some aspects, a user equipment (UE) may transmit a first sounding reference signal (SRS) via a first antenna. The UE may transmit a second SRS via a second antenna, wherein the first antenna and the second antenna are not coherent. The UE may transmit a first physical uplink shared channel (PUSCH) communication via the first antenna. The UE may transmit a second PUSCH communication via the second antenna. The UE may receive a coherence compensation factor having a value in accordance with one or more phase differences associated with the first antenna and the second antenna. Numerous other aspects are described.

### FIELD OF THE DISCLOSURE

Aspects of the present disclosure generally relate to wireless communication and specifically relate to techniques, apparatuses, and methods associated with compensation for uplink non-coherence.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to transmit a first sounding reference signal (SRS) via a first antenna. The one or more processors may be configured to transmit a second SRS via a second antenna, wherein the first antenna and the second antenna are not coherent. The one or more processors may be configured to transmit a first physical uplink shared channel (PUSCH) communication via the first antenna. The one or more processors may be configured to transmit a second PUSCH communication via the second antenna. The one or more processors may be configured to receive a coherence compensation factor having a value in accordance with one or more phase differences associated with the first antenna and the second antenna.

Some aspects described herein relate to a network node for wireless communication. The network node may include one or more memories and one or more processors coupled to the one or more memories. The one or more processors may be configured to receive a first SRS via a first antenna of a UE. The one or more processors may be configured to receive a second SRS via a second antenna of the UE, wherein the first antenna and the second antenna are not coherent. The one or more processors may be configured to receive a first PUSCH communication via the first antenna. The one or more processors may be configured to receive a second PUSCH communication via the second antenna. The one or more processors may be configured to transmit, for the UE, a coherence compensation factor having a value in accordance with one or more phase differences associated with the first antenna and the second antenna.

Some aspects described herein relate to a method of wireless communication performed by a UE. The method may include transmitting a first SRS via a first antenna. The method may include transmitting a second SRS via a second antenna, wherein the first antenna and the second antenna are not coherent. The method may include transmitting a first PUSCH communication via the first antenna. The method may include transmitting a second PUSCH communication via the second antenna. The method may include receiving a coherence compensation factor having a value in accordance with one or more phase differences associated with the first antenna and the second antenna.

Some aspects described herein relate to a method of wireless communication performed by a network node. The method may include receiving a first SRS via a first antenna of a UE. The method may include receiving a second SRS via a second antenna of the UE, wherein the first antenna and the second antenna are not coherent. The method may include receiving a first PUSCH communication via the first antenna. The method may include receiving a second PUSCH communication via the second antenna. The method may include transmitting, for the UE, a coherence compensation factor having a value in accordance with one or more phase differences associated with the first antenna and the second antenna.

Some aspects described herein relate to a non-transitory computer-readable medium that stores a set of instructions for wireless communication by a UE. The set of instructions, when executed by one or more processors of the UE, may cause the UE to transmit a first SRS via a first antenna. The set of instructions, when executed by one or more processors of the UE, may cause the UE to transmit a second SRS via a second antenna, wherein the first antenna and the second antenna are not coherent. The set of instructions, when executed by one or more processors of the UE, may cause the UE to transmit a first PUSCH communication via the first antenna. The set of instructions, when executed by one or more processors of the UE, may cause the UE to transmit a second PUSCH communication via the second antenna. The set of instructions, when executed by one or more processors of the UE, may cause the UE to receive a coherence compensation factor having a value in accordance with one or more phase differences associated with the first antenna and the second antenna.

Some aspects described herein relate to a non-transitory computer-readable medium that stores a set of instructions for wireless communication by a network node. The set of instructions, when executed by one or more processors of the network node, may cause the network node to receive a first SRS via a first antenna of a UE. The set of instructions, when executed by one or more processors of the network node, may cause the network node to receive a second SRS via a second antenna of the UE, wherein the first antenna and the second antenna are not coherent. The set of instructions, when executed by one or more processors of the network node, may cause the network node to receive a first PUSCH communication via the first antenna. The set of instructions, when executed by one or more processors of the network node, may cause the network node to receive a second PUSCH communication via the second antenna. The set of instructions, when executed by one or more processors of the network node, may cause the network node to transmit, for the UE, a coherence compensation factor having a value in accordance with one or more phase differences associated with the first antenna and the second antenna.

Some aspects described herein relate to an apparatus for wireless communication. The apparatus may include means for transmitting a first SRS via a first antenna. The apparatus may include means for transmitting a second SRS via a second antenna, wherein the first antenna and the second antenna are not coherent. The apparatus may include means for transmitting a first PUSCH communication via the first antenna. The apparatus may include means for transmitting a second PUSCH communication via the second antenna. The apparatus may include means for receiving a coherence compensation factor having a value in accordance with one or more phase differences associated with the first antenna and the second antenna.

Some aspects described herein relate to an apparatus for wireless communication. The apparatus may include means for receiving a first SRS via a first antenna of a UE. The apparatus may include means for receiving a second SRS via a second antenna of the UE, wherein the first antenna and the second antenna are not coherent. The apparatus may include means for receiving a first PUSCH communication via the first antenna. The apparatus may include means for receiving a second PUSCH communication via the second antenna. The apparatus may include means for transmitting, for the UE, a coherence compensation factor having a value in accordance with one or more phase differences associated with the first antenna and the second antenna.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating an example of coherent and non-coherent uplink multiple-input multiple-output (MIMO) communication, in accordance with the present disclosure.

FIG. 5 is a diagram illustrating an example of partially coherent uplink MIMO communication, in accordance with the present disclosure.

FIG. 6 is a diagram illustrating an example associated with non-coherence compensation, in accordance with the present disclosure.

FIG. 7 is a diagram illustrating an example associated with uplink MIMO with a coherence compensation factor, in accordance with the present disclosure.

FIG. 8 is a diagram illustrating an example associated with a coherence compensation factor for uplink MIMO communications, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication system, “coherent” may refer to a communication in which the phase information of a transmitted signal is preserved and leveraged by a receiver for decoding the signal. Coherent communication schemes may use techniques such as phase-locked loops or pilot symbols to ensure that the receiver can accurately interpret the phase and amplitude characteristics of the received signal, improving performance in terms of signal fidelity and robustness.

“Non-coherent” refers to a communication scheme in which the receiver does not rely on phase information of the transmitted signal for decoding. Non-coherent schemes may use signal characteristics such as amplitude, frequency, or energy, rather than phase, to interpret the transmitted data. Non-coherent methods may be applicable in scenarios where phase information is difficult to maintain, such as in rapidly changing network environments or when there is a high likelihood of phase distortion during transmission.

In the context of uplink multiple-input multiple-output (MIMO) communication, a user equipment (UE) may be equipped with multiple transmitting antennas. Two or more of the antennas may be coherent or non-coherent relative to one another. The two or more antennas may be coherent if a phase difference between the antennas is within a 40-degree margin of error. If the phase difference between the two or more antennas exceeds the 40-degree margin of error, the two or more antennas may be non-coherent. The margin of error may occur as a result of a downlink interrupt or an uplink power change.

Each of the two or more antennas may be part of a subgroup of antennas. Antennas within the subgroup may be coherent or non-coherent relative to one another. If the antennas in one subgroup are coherent relative to one another but non-coherent relative to antennas in another subgroup, the UE may have partially coherent capabilities for uplink MIMO.

Whether a UE is capable of coherence for uplink MIMO may depend on hardware characteristics of the UE, processing power of the UE, environmental factors, channel conditions, and/or a combination thereof, among other examples. If the UE lacks the appropriate hardware and/or processing power, the UE may not be capable of coherence for uplink MIMO communications, even with favorable environmental factors and channel conditions. Network performance may be degraded without coherent uplink MIMO communication.

Various aspects relate generally to MIMO communication. Some aspects more specifically relate to non-coherent uplink MIMO communications. In some aspects, a network node may determine one or more phase differences between transmitting (Tx) antennas of a UE. In some aspects, the network node may determine one or more phase differences between uplink communications transmitted, via different Tx antennas, from the UE. For example, the network node may determine the phase differences in accordance with sounding reference signals (SRSs), demodulation reference signals (DMRSs), and/or a combination thereof, among other examples, transmitted from different Tx antennas. The network node may determine a coherence compensation factor from the phase differences, and the UE may apply the coherence compensation factor to subsequent uplink communications, such as a subsequent DMRS on a physical uplink control channel (PUSCH).

Particular aspects of the subject matter described in this disclosure can be implemented to realize one or more of the following potential advantages. In some examples, the described techniques can be used to allow a UE to perform coherent uplink MIMO communications. In some examples, the described techniques allow the UE to perform uplink MIMO communications even if the UE lacks hardware and/or software typically required for performing coherent uplink MIMO.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

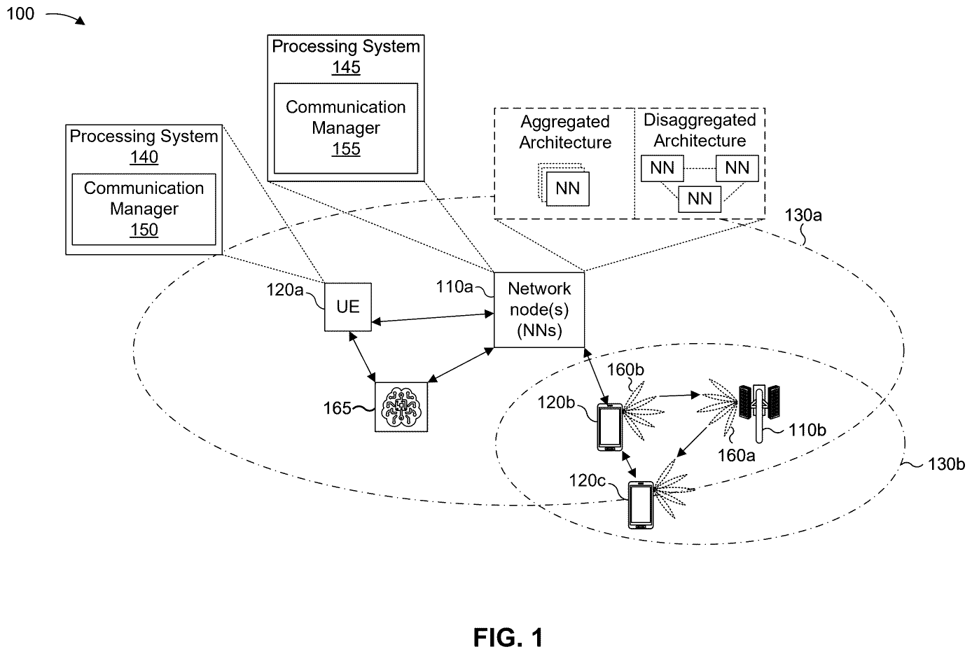

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

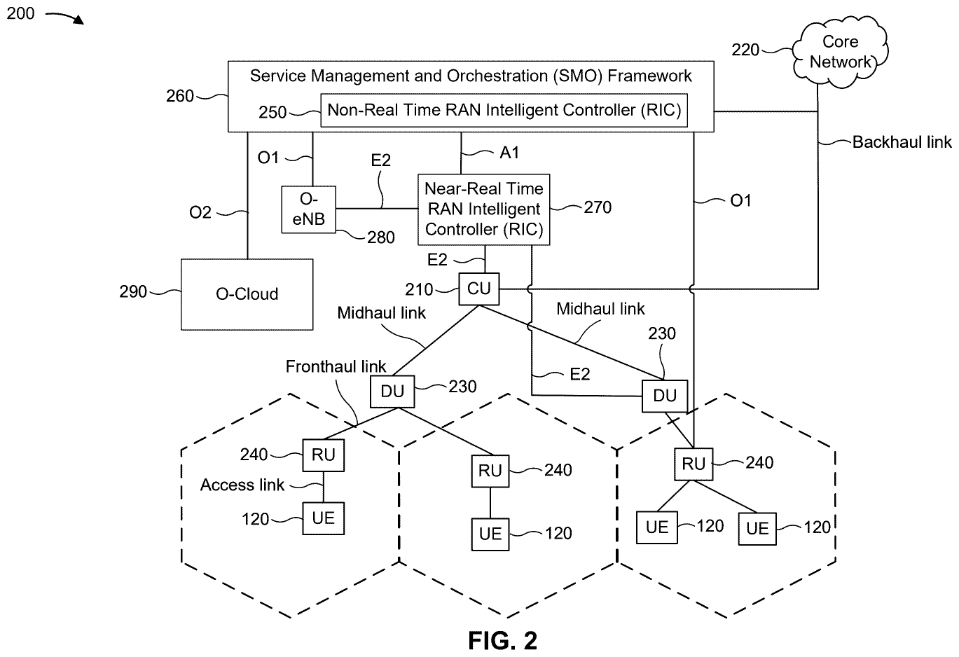

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit a first SRS via a first antenna; transmit a second SRS via a second antenna, wherein the first antenna and the second antenna are not coherent; transmit a first PUSCH communication via the first antenna; transmit a second PUSCH communication via the second antenna; and receive a coherence compensation factor having a value in accordance with one or more phase differences associated with the first antenna and the second antenna. Additionally, or alternatively, the communication manager 150 may perform one or more other operations described herein.

In some aspects, the network node 110 may include a communication manager 155. As described in more detail elsewhere herein, the communication manager 155 may receive a first SRS via a first antenna of a UE (e.g., UE 120); receive a second SRS via a second antenna of the UE, wherein the first antenna and the second antenna are not coherent; receive a first PUSCH communication via the first antenna; receive a second PUSCH communication via the second antenna; and transmit, for the UE, a coherence compensation factor having a value in accordance with one or more phase differences associated with the first antenna and the second antenna. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

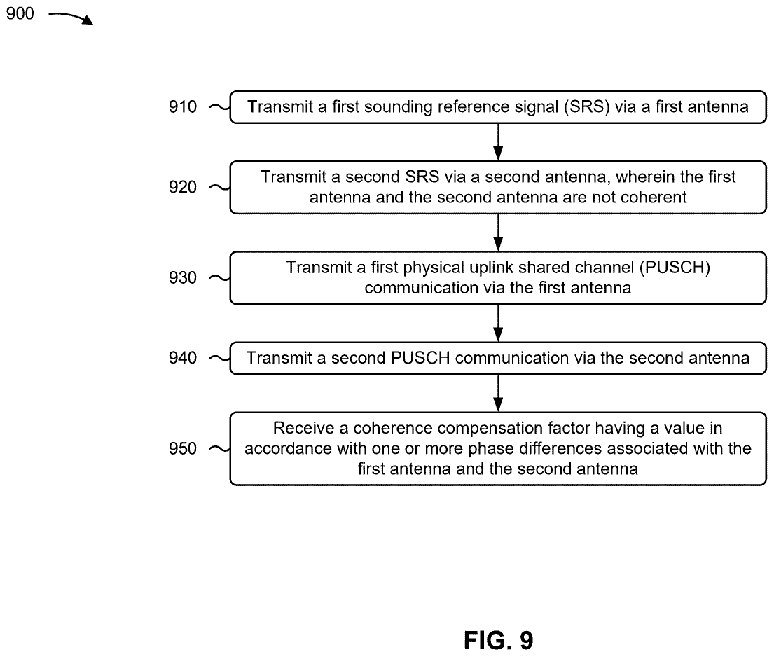

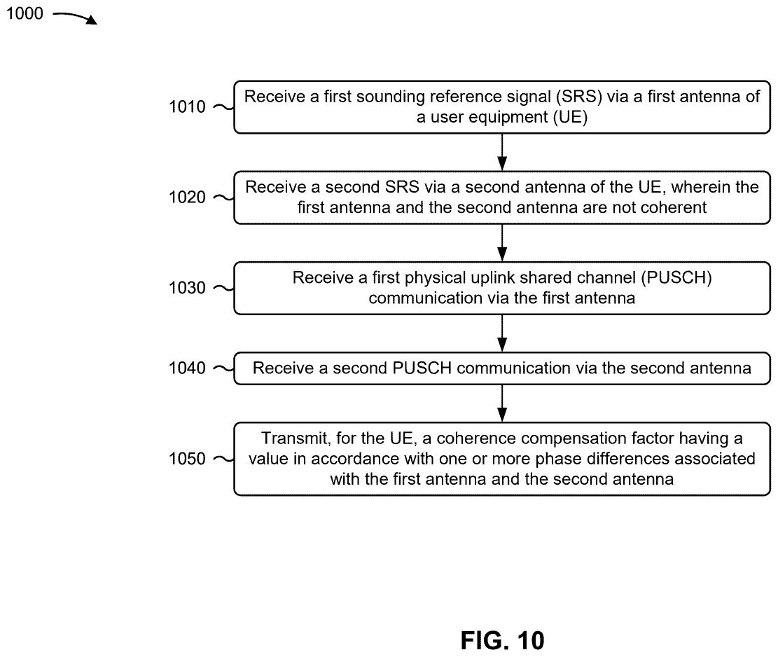

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with non-coherence uplink compensation, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

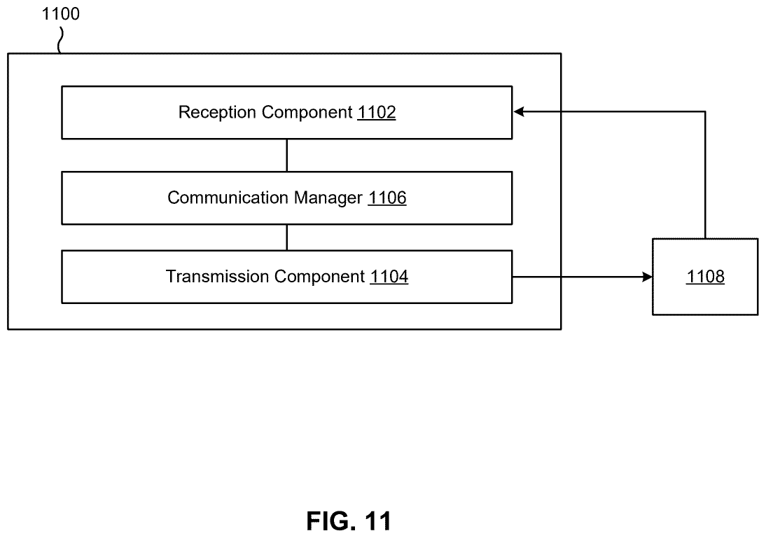

In some aspects, the UE 120 includes means for transmitting a first SRS via a first antenna; means for transmitting a second SRS via a second antenna, wherein the first antenna and the second antenna are not coherent; means for transmitting a first PUSCH communication via the first antenna; means for transmitting a second PUSCH communication via the second antenna; and/or means for receiving a coherence compensation factor having a value in accordance with one or more phase differences associated with the first antenna and the second antenna. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

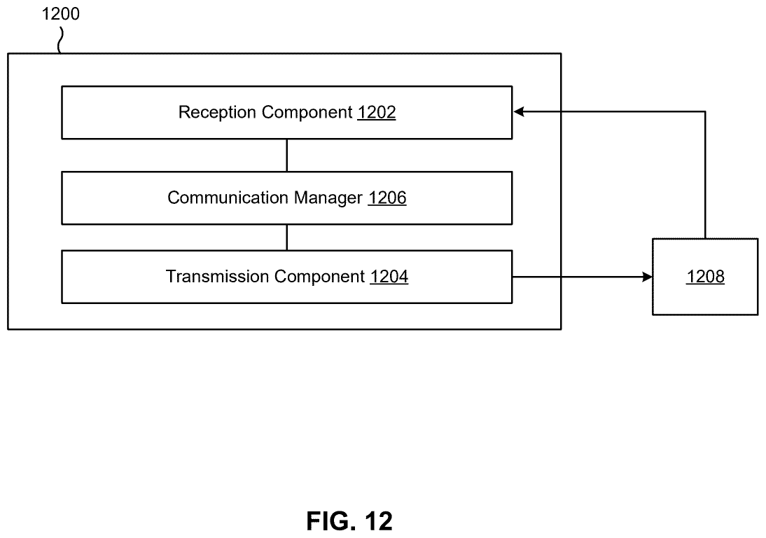

In some aspects, the network node 110 includes means for receiving a first SRS via a first antenna of a UE (e.g., UE 120); means for receiving a second SRS via a second antenna of the UE, wherein the first antenna and the second antenna are not coherent; means for receiving a first PUSCH communication via the first antenna; means for receiving a second PUSCH communication via the second antenna; and/or means for transmitting, for the UE, a coherence compensation factor having a value in accordance with one or more phase differences associated with the first antenna and the second antenna. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

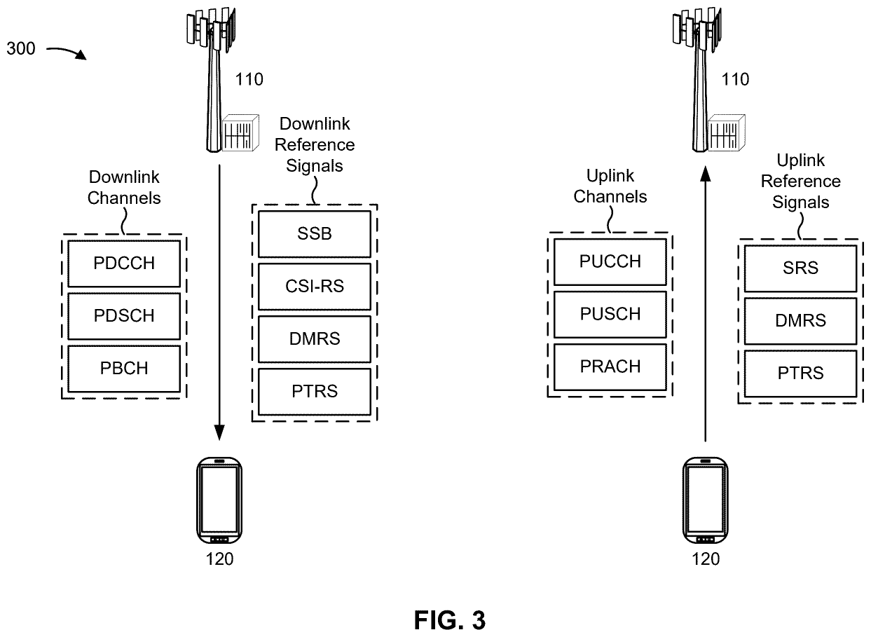

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH and/or the PUSCH.

As further shown, a downlink reference signal may include a SSB, a CSI-RS, a DMRS, a positioning reference signal (PRS), or a PTRS, among other examples. As also shown, an uplink reference signal may include an SRS, a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As discussed in greater detail below, uplink signals, such as the SRS and PUSCH communications, may be transmitted via multiple Tx antennas of a UE 120 to facilitate uplink MIMO communication. In some aspects, the SRS and PUSCH communications may be transmitted with a phase differential, which may be caused by a downlink interrupt, an uplink power change, and/or a combination thereof, among other examples. A UE 120 that is equipped for coherent uplink MIMO communication may reduce the phase differential, across the multiple antennas, between the SRS and the PUSCH communications. A UE 120 that is not equipped for coherent uplink MIMO communications, or is equipped for partially coherent uplink MIMO communications, may not be able to compensate for the phase differential, which may result in poor network performance.

As indicated above, FIG. 3 is provided as an example. Other examples may differ from what is described with regard to FIG. 3.

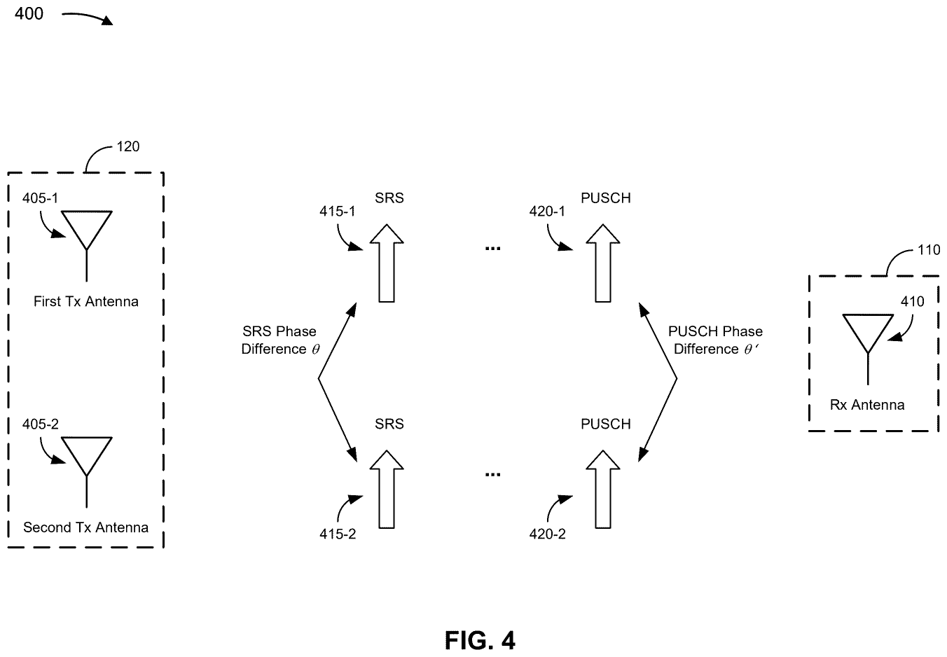

FIG. 4 is a diagram illustrating an example 400 of coherent and non-coherent uplink MIMO communication, in accordance with the present disclosure. As shown in the example 400 of FIG. 4, a UE 120 includes a first Tx antenna 405-1 and a second Tx antenna 405-2. A network node 110 includes a receiving (Rx) antenna 410. The UE 120 may transmit a first SRS 415-1 via the first Tx antenna 405-1 and a second SRS 415-2 via the second Tx antenna 405-2. The first SRS 415-1 and the second SRS 415-2 may be received at the network node 110 via the Rx antenna 410. Additionally, the UE 120 may transmit a first PUSCH communication 420-1 via the first Tx antenna 405-1 and a second PUSCH communication 420-2 via the second Tx antenna 405-2. In some aspects, the first PUSCH communication 420-1 may include a first DMRS and the second PUSCH communication 420-2 may include a second DMRS. The first PUSCH communication 420-1 and the second PUSCH communication 420-2 may be received at the network node 110 via the Rx antenna 410.

The UE 120 may transmit the first SRS 415-1 and the second SRS 415-2 in accordance with a first phase difference θ. Additionally, the UE 120 may transmit the first PUSCH communication 420-1 and the second PUSCH communication 420-2 with a second phase difference θ′. In some aspects, the first phase difference θ and the second phase difference θ′ may be within a margin of error, such as a 40-degree margin of error. If the UE 120 is capable of coherent uplink MIMO communication, the UE 120 may transmit uplink communications such that the first phase difference θ and the second phase difference θ′ are within a 40-degree margin of error relative to one another. If the UE 120 is not capable of coherent uplink MIMO communication, the margin of error between the first phase difference θ and the second phase difference θ′ may exceed the 40-degree margin of error relative to one another. A magnitude of the difference between the first phase difference θ and the second phase difference θ′ may be caused by a downlink interruption, an uplink transmission power change, and/or a combination thereof, among other examples.

As indicated above, FIG. 4 is provided as an example. Other examples may differ from what is described with respect to FIG. 4.

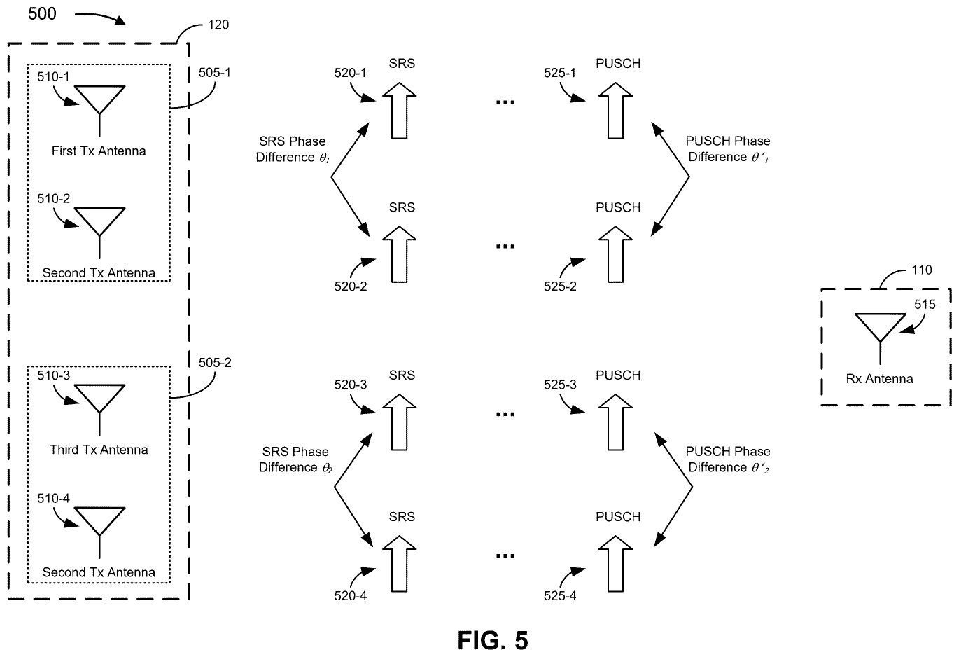

FIG. 5 is a diagram illustrating an example 500 of partially coherent uplink MIMO communication, in accordance with the present disclosure. As shown in the example 500 of FIG. 5, a UE 120 includes a first antenna group 505-1 that includes a first Tx antenna 510-1 and a second Tx antenna 510-2. The UE 120 further includes a second antenna group 505-2 that includes a third Tx antenna 510-3, and a fourth Tx antenna 510-4. A network node 110 includes an Rx antenna 515. The UE 120 may transmit a first SRS 520-1 via the first Tx antenna 510-1, a second SRS 520-2 via the second Tx antenna 510-2, a third SRS 520-3 via the third Tx antenna 510-3, and a fourth SRS 520-4 via the fourth Tx antenna 510-4. The first SRS 520-1, the second SRS 520-2, the third SRS 520-3, and the fourth SRS 520-4 may be received at the network node 110 via the Rx antenna 515. Additionally, the UE 120 may transmit a first PUSCH communication 525-1 via the first Tx antenna 510-1, a second PUSCH communication 525-2 via the second Tx antenna 510-2, a third PUSCH communication 525-3 via the third Tx antenna 510-3, and a fourth PUSCH communication 525-4 via the fourth Tx antenna 510-4. In some aspects, the first PUSCH communication 525-1 may include a first DMRS, the second PUSCH communication 525-2 may include a second DMRS, the third PUSCH communication 525-3 may include a third DMRS, and the fourth PUSCH communication 525-4 may include a fourth DMRS. The first PUSCH communication 525-1, the second PUSCH communication 525-2, the third PUSCH communication 525-3, and the fourth PUSCH communication 525-4 may be received at the network node 110 via the Rx antenna 515.

The UE 120 may transmit, via the first Tx antenna 510-1 and the second Tx antenna 510-2, respectively, the first SRS 520-1 and the second SRS 520-2 in accordance with a first SRS phase difference θ₁. Additionally, the UE 120 may transmit, via the first Tx antenna 510-1 and the second Tx antenna 510-2, respectively, the first PUSCH communication 525-1 and the second PUSCH communication 525-2 with a first PUSCH phase difference θ′₁. The UE 120 may transmit, via the third Tx antenna 510-3 and the fourth Tx antenna 510-4, respectively, the third SRS 520-3 and the fourth SRS 520-4 in accordance with a second SRS phase difference θ₂. Additionally, the UE 120 may transmit, via the third Tx antenna 510-3 and the fourth Tx antenna 510-4, respectively, the third PUSCH communication 525-3 and the fourth PUSCH communication 525-4 with a second PUSCH phase difference θ′₂.

In some aspects, the first SRS phase difference θ₁ and the first PUSCH phase difference θ′₁ may be within a margin of error, such as a 40-degree margin of error relative to one another. In some aspects, the second SRS phase difference θ₂ and the second PUSCH phase difference θ′₂ may be within a margin of error, such as a 40-degree margin of error relative to one another. Accordingly, the first Tx antenna 510-1 and the second Tx antenna 510-2 may be coherent relative to one another. Additionally, the third Tx antenna 510-3 and the fourth Tx antenna 510-4 may be coherent relative to one another. The Tx antennas of the first antenna group 505-1 (e.g., the first Tx antenna 510-1 and the second Tx antenna 510-2) may not be coherent with the Tx antennas of the second antenna group 505-2 (e.g., the third Tx antenna 510-3 and the fourth Tx antenna 510-4). Therefore, the first SRS phase difference θ₁ and the second SRS phase difference θ₂ may have a phase differential greater than, for example, the 40-degree margin of error associated with coherence. Additionally, the first PUSCH phase difference θ′₁ and the second PUSCH phase difference θ′₂ may have a phase differential greater than, for example, the 40-degree margin of error associated with coherence.

As indicated above, FIG. 5 is provided as an example. Other examples may differ from what is described with respect to FIG. 5.

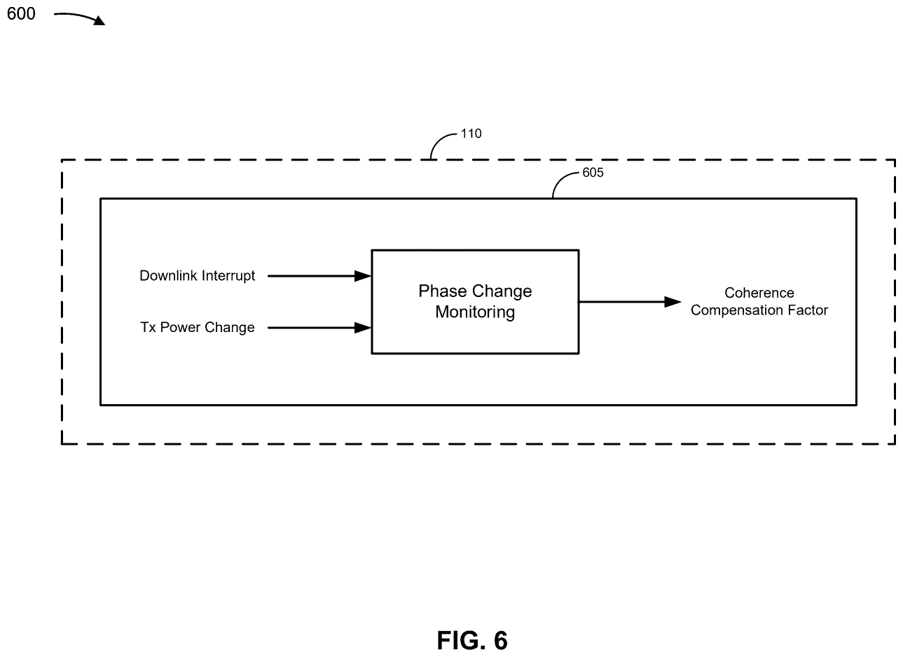

FIG. 6 is a diagram illustrating an example 600 associated with non-coherence compensation, in accordance with the present disclosure. As shown in FIG. 6, a non-coherence compensation factor may be determined, by the network node 110, during a learning operation 605. The learning operation 605 may include modeling a phase difference θ as a result of a downlink interrupt, a Tx power change, and/or a combination thereof, among other examples. The downlink interrupt may occur when a UE (e.g., the UE 120) switches from receiving one or more downlink communications to transmitting one or more uplink communications. The Tx power change may occur when a UE begins transmitting uplink communications at a different power level than a power level used to transmit one or more previous uplink communications. During the learning operation 605, the network node 110 may monitor how a phase of uplink communications (e.g., SRSs and/or PUSCH communications) changes as a result of the downlink interrupt, the Tx power change, and/or a combination thereof, among other examples.

An output of the learning operation 605 may include a coherence compensation factor. The coherence compensation factor, when applied by the UE, may reduce the phase difference θ between Tx antennas of the UE to within, for example, the 40-degree margin of error associated with coherent uplink MIMO communication. In some aspects, the coherence compensation factor, when applied by the UE, may reduce an SRS phase difference, a PUSCH phase difference, and/or a combination thereof, among other examples.

In some aspects, the network node may determine the coherence compensation factor for one Tx antenna (e.g., a first Tx antenna) in accordance with the following estimation:

$${a}_{1} = {( {y}_{1} \cdot {s}_{1}^{*} )}^{*} ( {z}_{1} \cdot {{s}^{′}}_{1}^{*} ) = {{h}_{1} ( {{h}^{′}}_{1} )}^{*} {e}^{j ( {∅}_{1} - {θ}_{1} )}$$

where h₁ is a physical raw channel from the first Tx antenna of the UE to the network node at SRS sounding, s₁ (e.g., s₁e^{jθ}^{₁}) is associated with an SRS transmission signal from the first Tx antenna to the network node at SRS sounding, h′₁ is a physical raw channel from the first Tx antenna of the UE to the network node at the PUSCH communication, s′₁ (e.g., s′₁e^{jØ}^{₁}) is associated with a PUSCH communication (e.g., a DMRS) from the first Tx antenna of the UE to the network node, y₁=h₁s₁e^{jθ}^{₁} (e.g., the SRS transmitted via the first Tx antenna of the UE received at the network node), and z₁=h′₁s′₁e^{jØ}^{₁} (e.g., the DMRS transmitted via the first Tx antenna of the UE received at the network node). In some aspects, Ø₁ may represent the phase of the DMRS (or another PUSCH communication) transmitted via the first Tx antenna, and Ø₁ may represent the phase of the SRS transmitted via the first Tx antenna.

In some aspects, the network node may calculate a first phase change Δ₁ between the SRS and DMRS transmissions of the first Tx antenna. For example, if h₁≅h′₁, which may occur if the channel does not change between transmission of the SRS and transmission of the PUSCH (e.g., the DMRS), the network node may estimate the first phase change Δ₁ as follows as follows:

$${Δ}_{1} = {∅}_{1} - {θ}_{1} = {tan}^{- 1} ( \frac{real ( {a}_{1} )}{imaginary ( {a}_{1} )} ) .$$

Additionally, in some aspects, the network node may determine the coherence compensation factor for another Tx antenna (e.g., a second Tx antenna) in accordance with the following estimation:

$${a}_{2} = {( {y}_{2} \cdot {s}_{2}^{*} )}^{*} ( {z}_{2} \cdot {{s}^{′}}_{2}^{*} ) = {{h}_{2} ( {{h}^{′}}_{2} )}^{*} {e}^{j ( {∅}_{2} - {θ}_{2} )}$$

where h₂ is a physical raw channel from the second Tx antenna of the UE to the network node at SRS sounding, s₂ (e.g., s₂e^{jθ}^{₂}) is associated with an SRS transmission signal from the second Tx antenna to the network node at SRS sounding, h′₂ is a physical raw channel from the second Tx antenna of the UE to the network node at the PUSCH communication, s′₂ (e.g., s′₂e^{jØ}^{₂}) is associated with a PUSCH communication (e.g., a DMRS) from the second Tx antenna of the UE to the network node, y₂=h₂s₂e^{jθ}^{₂} (e.g., the SRS transmitted via the second Tx antenna of the UE received at the network node), and z₂=h′₂s′₂e^{jØ}^{₂} (e.g., the DMRS transmitted via the second Tx antenna of the UE received at the network node). In some aspects, Ø₂ may represent the phase of the DMRS (or another PUSCH communication) transmitted via the second Tx antenna and θ₂ may represent the phase of the SRS transmitted via the second Tx antenna.

In some aspects, the network node may calculate a second phase change Δ₂ between the SRS and DMRS transmissions of the second Tx antenna. For example, if h₂≅h′₂, which may occur if the channel does not change between transmission of the SRS and transmission of the PUSCH (e.g., the DMRS), the network node may estimate the second phase change Δ₂ as follows as follows:

$${Δ}_{2} = {∅}_{2} - {θ}_{2} = {tan}^{- 1} ( \frac{real ( {a}_{2} )}{imaginary ( {a}_{2} )} ) .$$

To determine the first phase change Δ₁ and the second phase change Δ₂, the network node may calculate a coherence compensation factor Δ. In some aspects, the coherence compensation factor Δ may be defined as follows:

$$Δ = {Δ}_{2} - {Δ}_{1} .$$

The network node may transmit, to the UE, the coherence compensation factor Δ. The UE may apply the coherence compensation factor Δ to one or more uplink communications. For example, the UE may apply the coherence compensation factor Δ to PUSCH communications (e.g., a DMRS) transmitted from the first Tx antenna. When the coherence compensation factor is applied to the PUSCH communications from the first Tx antenna, the PUSCH communication may be transmitted with a scaling factor associated with [symbol] . By applying the coherence compensation factor Δ, the DMRS (or other PUSCH communication) transmitted from the first Tx antenna may be coherent (e.g., within a 40-degree margin of error) with the DMRS transmitted from the second Tx antenna.

As indicated above, FIG. 6 is provided as an example. Other examples may differ from what is described with respect to FIG. 6.

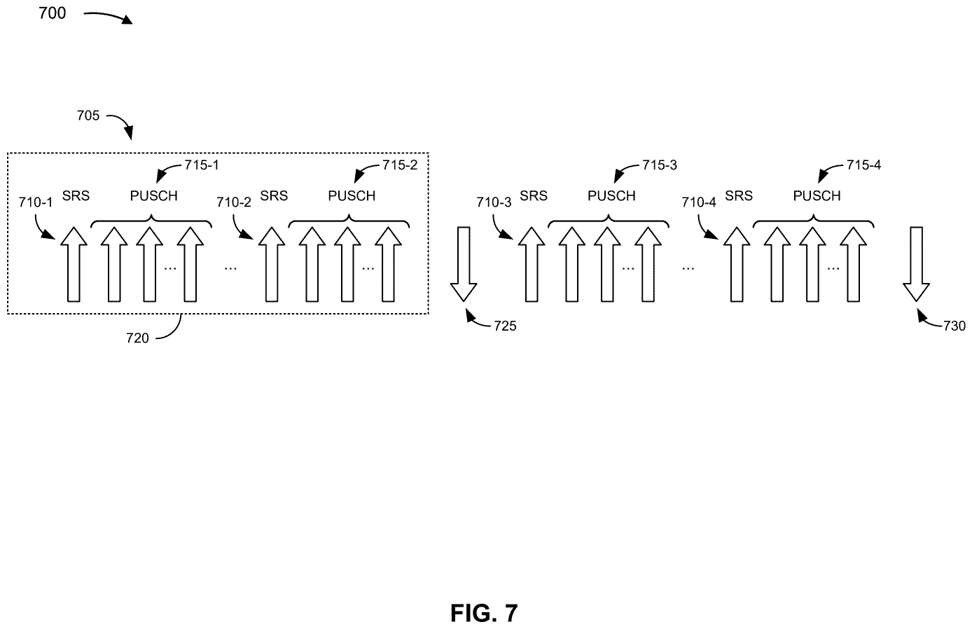

FIG. 7 is a diagram illustrating an example 700 associated with uplink MIMO with a coherence compensation factor, in accordance with the present disclosure. As shown in FIG. 7, example 700 includes a signaling diagram 705 representing uplink MIMO. The signaling diagram 705 includes a first SRS 710-1 transmitted via a first Tx antenna of a UE (e.g., UE 120), a second SRS 710-2 transmitted via a second Tx antenna of the UE, a third SRS 710-3 transmitted via the first Tx antenna of the UE, and a fourth SRS 710-4 transmitted via the second Tx antenna of the UE. The signaling diagram 705 also includes a first set of PUSCH communications 715-1 transmitted via the first Tx antenna of the UE and a second set of PUSCH communications 715-2 transmitted via the second Tx antenna of the UE. In some aspects, the first set of PUSCH communications 715-1 may be transmitted, via the first Tx antenna, after the first SRS 710-1 and before the second SRS 710-2. In some aspects, the second set of PUSCH communications 715-2 may be transmitted, via the second Tx antenna, after the second SRS 710-2.

In some aspects, the first SRS 710-1, the second SRS 710-2, the first set of PUSCH communications 715-1, and the second set of PUSCH communications 715-2 may be transmitted while the network node (e.g., network node 110) is performing a learning operation 720, such as the learning operation 605 discussed above with respect to FIG. 6.

In some aspects, following the learning operation, the network node may transmit, and the UE may receive, a coherence compensation factor (e.g., the coherence compensation factor Δ, discussed above with respect to the example 600 of FIG. 6) via downlink signaling 725, such as a MAC-CE in a PDSCH. The UE may apply the coherence compensation factor to the transmission of a third set of PUSCH communications 715-3 via the first Tx antenna. In some aspects, the UE may apply the coherence compensation factor to the transmission of the third SRS 710-3. In some aspects, the third set of PUSCH communications 715-3 may be transmitted, via the first Tx antenna, after the third SRS 710-3 is transmitted. In some aspects, a fourth set of PUSCH communications 715-4 may be transmitted, via the second Tx antenna, after the fourth SRS 710-4 is transmitted.

When the coherence compensation factor is applied to the third set of PUSCH communications 715-3, the third set of PUSCH communications 715-3, transmitted via the first Tx antenna, may be coherent with a fourth set of PUSCH communications 715-4, transmitted via the second Tx antenna. In some aspects, the third set of PUSCH communications 715-3 may be coherent with the fourth set of PUSCH communications 715-4 if a phase difference between the third set of PUSCH communications 715-3 and the fourth set of PUSCH communications 715-4 is within a margin of error (e.g., a 40-degree margin of error associated with coherence).

In some aspects, the network node may determine an updated coherence compensation factor. In some aspects, the updated coherence compensation factor may be determined in accordance with a learning operation performed by the network node during transmission of the third SRS 710-3, the fourth SRS 710-4, the third set of PUSCH communications 715-3, and the fourth set of PUSCH communications 715-4. In some aspects, the updated coherence compensation factor may be transmitted to the UE via downlink signaling 730 such as a MAC-CE in a PDSCH.

With the coherence compensation factor, the UE may transmit uplink MIMO communications with coherence (e.g., uplink MIMO communications with a phase difference within a 40-degree margin of error), even if the UE is not otherwise equipped with hardware and/or software for transmitting coherent uplink MIMO communications.

As indicated above, FIG. 7 is provided as an example. Other examples may differ from what is described with respect to FIG. 7.

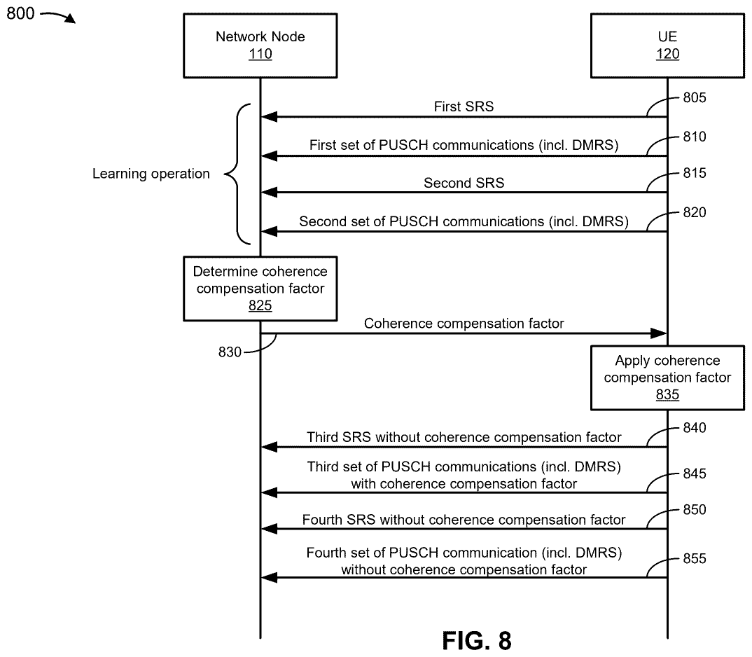

FIG. 8 is a diagram illustrating an example 800 associated with a coherence compensation factor for uplink MIMO communications, in accordance with the present disclosure. As shown in FIG. 8, a network node 110 and a UE 120 may communicate with one another.

As shown by reference number 805, the UE 120 may transmit, and the network node 110 may receive, a first SRS. In some aspects, the UE 120 may transmit the first SRS via a first Tx antenna. In some aspects, the first Tx antenna may be part of a first antenna group.

As shown by reference number 810, the UE 120 may transmit, and the network node 110 may receive, a first set of PUSCH communications. In some aspects, the first set of PUSCH communications may be transmitted via the first Tx antenna of the UE 120. In some aspects, the first set of PUSCH communications may include a DMRS (e.g., a first DMRS).

As shown by reference number 815, the UE 120 may transmit, and the network node 110 may receive, a second SRS. In some aspects, the UE 120 may transmit the second SRS via a second Tx antenna. In some aspects, the second antenna may be non-coherent relative to the first antenna. In some aspects, the second Tx antenna may be part of a second antenna group, different from the first antenna group. In some aspects, the second antenna group and the first antenna group may be non-coherent relative to one another (e.g., communications from the first antenna group and the second antenna group may have a phase difference greater than, for example, a 40-degree margin of error), even if Tx antennas in the first antenna group are coherent and Tx antennas in the second antenna group are coherent.

As shown by reference number 820, the UE 120 may transmit, and the network node 110 may receive, a second set of PUSCH communication. In some aspects, the second set of PUSCH communication is transmitted via the second Tx antenna of the UE 120. In some aspects, the second set of PUSCH communication includes a DMRS (e.g., a second DMRS).

As shown by reference number 825, the network node 110 may determine a coherence compensation factor. In some aspects, the network node 110 may determine the coherence compensation factor in accordance with one or more phase differences. For example, the network node 110 may determine the coherence compensation factor in accordance with a phase difference between the first Tx antenna of the UE 120 and the second Tx antenna of the UE 120. In some aspects, as discussed above, the network node 110 may determine the coherence compensation factor in accordance with a phase difference (e.g., an SRS phase difference) associated with the first SRS and the second SRS. In some aspects, as discussed above, the network node 110 may determine the coherence compensation factor in accordance with a phase difference (e.g., a PUSCH phase difference) associated with a first PUSCH communication (e.g., the first DMRS) in the first set of PUSCH communications and a second PUSCH communication (e.g., the second DMRS) the second set of PUSCH communications.

As shown by reference number 830, the network node 110 may transmit, and the UE 120 may receive, the coherence compensation factor determined by the network node 110. As discussed above, the coherence compensation factor may have a value in accordance with one or more phase differences associated with the first Tx antenna and the second Tx antenna. In some aspects, the network node 110 may transmit, and the UE 120 may receive, the coherence compensation factor via a MAC-CE.

As shown by reference number 835, the UE 120 may apply the coherence compensation factor. For example, in some aspects, the UE 120 may configure itself to transmit one or more uplink communications (e.g., the SRS and/or one or more PUSCH communications such as the DMRS) in accordance with the coherence compensation factor. In some aspects, the UE 120 may configure itself to apply the coherence compensation factor to fewer than all Tx antennas of the UE 120. For example, the UE 120 may configure itself to apply the coherence compensation factor to uplink communications transmitted via the first Tx antenna but not to uplink communications transmitted via the second Tx antenna. Further, in some aspects, the UE 120 may configure itself to apply the coherence compensation factor to PUSCH communications via the first Tx antenna and not to SRS communications via the first Tx antenna. In some aspects, as discussed above, applying the coherence compensation factor may reduce the one or more phase differences to within an error margin associated with antenna coherence. In some aspects, the error margin associated with antenna coherence may be a 40-degree margin of error.

As shown by reference number 840, the UE 120 may transmit, and the network node 110 may receive, a third SRS. In some aspects, the UE 120 may transmit the third SRS via a first Tx antenna. In some aspects, the third SRS may be transmitted without the coherence compensation factor.

As shown by reference number 845, the UE 120 may transmit, and the network node 110 may receive, a third set of PUSCH communications. In some aspects, the third set of PUSCH communications are transmitted via the first Tx antenna of the UE 120. In some aspects, the third set of PUSCH communications may include a DMRS (e.g., a third DMRS). In some aspects, the third set of PUSCH communications, including the third DMRS, may be transmitted in accordance with the coherence compensation factor. By applying the coherence compensation factor to the third set of PUSCH communications, the third set of PUSCH communications (including the third DMRS) may be coherent (e.g., within a 40-degree margin of error) with transmissions via the second Tx antenna.

As shown by reference number 850, the UE 120 may transmit, and the network node 110 may receive, a fourth SRS. In some aspects, the fourth SRS may be transmitted via the second Tx antenna without applying the coherence compensation factor.

As shown by reference number 855, the UE 120 may transmit, and the network node 110 may receive, a fourth set of PUSCH communications. In some aspects, the fourth set of PUSCH communication may be transmitted via the second Tx antenna of the UE 120. In some aspects, the second set of PUSCH communications may include a DMRS (e.g., a fourth DMRS). In some aspects, the fourth set of PUSCH communications (including the fourth DMRS) may be transmitted without the UE 120 applying the coherence compensation factor.

In some aspects, as discussed above, the network node 110 may perform a subsequent learning operation and send an updated coherence compensation factor to the UE 120. Accordingly, the network node 110 may adjust the coherence compensation factor to account for changes in the network that may cause non-coherence between the Tx antennas of the UE 120. Additionally, in some aspects, the network node 110 may determine, and the UE 120 may apply, the coherence compensation factor for the UE 120 with multiple Tx antennas and/or a network node 110 with multiple receivers. Accordingly, the examples described herein may be applicable to a single tap channel or a multi-tap channel.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with uplink non-coherence compensation.

As shown in FIG. 9, in some aspects, process 900 may include transmitting a first SRS via a first antenna (block 910). For example, the UE (e.g., using transmission component 1104 and/or communication manager 1106, depicted in FIG. 11) may transmit a first SRS via a first antenna, as described above.

As further shown in FIG. 9, in some aspects, process 900 may include transmitting a second SRS via a second antenna, wherein the first antenna and the second antenna are not coherent (block 920). For example, the UE (e.g., using transmission component 1104 and/or communication manager 1106, depicted in FIG. 11) may transmit a second SRS via a second antenna, wherein the first antenna and the second antenna are not coherent, as described above.

As further shown in FIG. 9, in some aspects, process 900 may include transmitting a first PUSCH communication via the first antenna (block 930). For example, the UE (e.g., using transmission component 1104 and/or communication manager 1106, depicted in FIG. 11) may transmit a first PUSCH communication via the first antenna, as described above.

As further shown in FIG. 9, in some aspects, process 900 may include transmitting a second PUSCH communication via the second antenna (block 940). For example, the UE (e.g., using transmission component 1104 and/or communication manager 1106, depicted in FIG. 11) may transmit a second PUSCH communication via the second antenna, as described above.

As further shown in FIG. 9, in some aspects, process 900 may include receiving a coherence compensation factor having a value in accordance with one or more phase differences associated with the first antenna and the second antenna (block 950). For example, the UE (e.g., using reception component 1102 and/or communication manager 1106, depicted in FIG. 11) may receive a coherence compensation factor having a value in accordance with one or more phase differences associated with the first antenna and the second antenna, as described above.

Process 900 may include additional aspects, such as any single aspect or any combination of aspects described below and/or in connection with one or more other processes described elsewhere herein.

In a first aspect, at least one of the one or more phase differences includes an SRS phase difference between the first SRS and the second SRS.

In a second aspect, alone or in combination with the first aspect, at least one of the one or more phase differences includes a PUSCH phase difference between the first PUSCH communication and the second PUSCH communication.

In a third aspect, alone or in combination with one or more of the first and second aspects, process 900 includes transmitting a third SRS via the first antenna, transmitting a fourth SRS via the second antenna, and transmitting, in accordance with the coherence compensation factor, a third PUSCH communication via the first antenna.

In a fourth aspect, alone or in combination with one or more of the first through third aspects, process 900 includes transmitting a fourth PUSCH communication via the second antenna, wherein the fourth PUSCH is transmitted without applying the coherence compensation factor.

In a fifth aspect, alone or in combination with one or more of the first through fourth aspects, process 900 includes applying the coherence compensation factor to one or more uplink communications transmitted via the first antenna.

In a sixth aspect, alone or in combination with one or more of the first through fifth aspects, applying the coherence compensation factor reduces the one or more phase differences to an error margin associated with antenna coherence.

In a seventh aspect, alone or in combination with one or more of the first through sixth aspects, receiving the coherence compensation factor includes receiving, from a network node, the coherence compensation factor via a MAC-CE.

In an eighth aspect, alone or in combination with one or more of the first through seventh aspects, the first antenna is part of a first antenna subgroup and the second antenna is part of a second antenna subgroup, and the first antenna subgroup lacks coherence relative to the second antenna subgroup.

In a ninth aspect, alone or in combination with one or more of the first through eighth aspects, the first PUSCH communication is a first DMRS and the second PUSCH communication is a second DMRS.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with uplink non-coherence compensation.

As shown in FIG. 10, in some aspects, process 1000 may include receiving a first SRS via a first antenna of a UE (block 1010). For example, the network node (e.g., using reception component 1202 and/or communication manager 1206, depicted in FIG. 12) may receive a first SRS via a first antenna of a UE, as described above.

As further shown in FIG. 10, in some aspects, process 1000 may include receiving a second SRS via a second antenna of the UE, wherein the first antenna and the second antenna are not coherent (block 1020). For example, the network node (e.g., using reception component 1202 and/or communication manager 1206, depicted in FIG. 12) may receive a second SRS via a second antenna of the UE, wherein the first antenna and the second antenna are not coherent, as described above.

As further shown in FIG. 10, in some aspects, process 1000 may include receiving a first PUSCH communication via the first antenna (block 1030). For example, the network node (e.g., using reception component 1202 and/or communication manager 1206, depicted in FIG. 12) may receive a first PUSCH communication via the first antenna, as described above.

As further shown in FIG. 10, in some aspects, process 1000 may include receiving a second PUSCH communication via the second antenna (block 1040). For example, the network node (e.g., using reception component 1202 and/or communication manager 1206, depicted in FIG. 12) may receive a second PUSCH communication via the second antenna, as described above.

As further shown in FIG. 10, in some aspects, process 1000 may include transmitting, for the UE, a coherence compensation factor having a value in accordance with one or more phase differences associated with the first antenna and the second antenna (block 1050). For example, the network node (e.g., using transmission component 1204 and/or communication manager 1206, depicted in FIG. 12) may transmit, for the UE, a coherence compensation factor having a value in accordance with one or more phase differences associated with the first antenna and the second antenna, as described above.

Process 1000 may include additional aspects, such as any single aspect or any combination of aspects described below and/or in connection with one or more other processes described elsewhere herein.

In a first aspect, at least one of the one or more phase differences includes an SRS phase difference between the first SRS and the second SRS.

In a second aspect, alone or in combination with the first aspect, at least one of the one or more phase differences includes a PUSCH phase difference between the first PUSCH communication and the second PUSCH communication.

In a third aspect, alone or in combination with one or more of the first and second aspects, process 1000 includes receiving a third SRS via the first antenna, receiving a fourth SRS via the second antenna, and receiving, in accordance with the coherence compensation factor, a third PUSCH communication via the first antenna.

In a fourth aspect, alone or in combination with one or more of the first through third aspects, process 1000 includes receiving a fourth PUSCH communication via the second antenna.

In a fifth aspect, alone or in combination with one or more of the first through fourth aspects, process 1000 includes estimating the coherence compensation factor.

In a sixth aspect, alone or in combination with one or more of the first through fifth aspects, the coherence compensation factor is estimated in accordance with a phase difference between the first SRS and the second SRS and a phase difference between the first PUSCH communication and the second PUSCH communication.

In a seventh aspect, alone or in combination with one or more of the first through sixth aspects, transmitting the coherence compensation factor includes transmitting the coherence compensation factor via a MAC-CE.

In an eighth aspect, alone or in combination with one or more of the first through seventh aspects, the first PUSCH communication is a first DMRS and the second PUSCH communication is a second DMRS.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a first SRS via a first antenna. The transmission component 1104 may transmit a second SRS via a second antenna, wherein the first antenna and the second antenna are not coherent. The transmission component 1104 may transmit a first PUSCH communication via the first antenna. The transmission component 1104 may transmit a second PUSCH communication via the second antenna. The reception component 1102 may receive a coherence compensation factor having a value in accordance with one or more phase differences associated with the first antenna and the second antenna.

The transmission component 1104 may transmit a third SRS via the first antenna transmitting a fourth SRS via the second antenna; and transmitting, in accordance with the coherence compensation factor, a third PUSCH communication via the first antenna. The transmission component 1104 may transmit a fourth PUSCH communication via the second antenna, wherein the fourth PUSCH is transmitted without applying the coherence compensation factor. The communication manager 1106 may apply the coherence compensation factor to one or more uplink communications transmitted via the first antenna.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 3-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a first SRS via a first antenna of a UE. The reception component 1202 may receive a second SRS via a second antenna of the UE, wherein the first antenna and the second antenna are not coherent. The reception component 1202 may receive a first PUSCH communication via the first antenna. The reception component 1202 may receive a second PUSCH communication via the second antenna. The transmission component 1204 may transmit, for the UE, a coherence compensation factor having a value in accordance with one or more phase differences associated with the first antenna and the second antenna.

The reception component 1202 may receive a third SRS via the first antenna. The reception component 1202 may receive a fourth SRS via the second antenna. The reception component 1202 may receive, in accordance with the coherence compensation factor, a third PUSCH communication via the first antenna. The reception component 1202 may receive a fourth PUSCH communication via the second antenna. The communication manager 1206 may estimate the coherence compensation factor.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: transmitting a first SRS via a first antenna; transmitting a second SRS via a second antenna, wherein the first antenna and the second antenna are not coherent; transmitting a first PUSCH communication via the first antenna; transmitting a second PUSCH communication via the second antenna; and receiving a coherence compensation factor having a value in accordance with one or more phase differences associated with the first antenna and the second antenna.

Aspect 2: The method of Aspect 1, wherein at least one of the one or more phase differences includes an SRS phase difference between the first SRS and the second SRS.

Aspect 3: The method of any of Aspects 1-2, wherein at least one of the one or more phase differences includes a PUSCH phase difference between the first PUSCH communication and the second PUSCH communication.

Aspect 4: The method of any of Aspects 1-3, further comprising: transmitting a third SRS via the first antenna; transmitting a fourth SRS via the second antenna; and transmitting, in accordance with the coherence compensation factor, a third PUSCH communication via the first antenna.

Aspect 5: The method of Aspect 4, further comprising transmitting a fourth PUSCH communication via the second antenna, wherein the fourth PUSCH is transmitted without applying the coherence compensation factor.

Aspect 6: The method of any of Aspects 1-5, further comprising applying the coherence compensation factor to one or more uplink communications transmitted via the first antenna.

Aspect 7: The method of Aspect 6, wherein applying the coherence compensation factor reduces the one or more phase differences to an error margin associated with antenna coherence.

Aspect 8: The method of any of Aspects 1-7, wherein receiving the coherence compensation factor includes receiving, from a network node, the coherence compensation factor via a MAC-CE.

Aspect 9: The method of any of Aspects 1-8, wherein the first antenna is part of a first antenna subgroup and the second antenna is part of a second antenna subgroup, and wherein the first antenna subgroup lacks coherence relative to the second antenna subgroup.

Aspect 10: The method of any of Aspects 1-9, wherein the first PUSCH communication is a first DMRS and the second PUSCH communication is a second DMRS.

Aspect 11: A method of wireless communication performed by a network node, comprising: receiving a first SRS via a first antenna of a UE; receiving a second SRS via a second antenna of the UE, wherein the first antenna and the second antenna are not coherent; receiving a first PUSCH communication via the first antenna; receiving a second PUSCH communication via the second antenna; and transmitting, for the UE, a coherence compensation factor having a value in accordance with one or more phase differences associated with the first antenna and the second antenna.

Aspect 12: The method of Aspect 11, wherein at least one of the one or more phase differences includes an SRS phase difference between the first SRS and the second SRS.

Aspect 13: The method of any of Aspects 11-12, wherein at least one of the one or more phase differences includes a PUSCH phase difference between the first PUSCH communication and the second PUSCH communication.

Aspect 14: The method of any of Aspects 11-13, further comprising: receiving a third SRS via the first antenna; receiving a fourth SRS via the second antenna; and receiving, in accordance with the coherence compensation factor, a third PUSCH communication via the first antenna.

Aspect 15: The method of Aspect 14, further comprising receiving a fourth PUSCH communication via the second antenna.

Aspect 16: The method of any of Aspects 11-15, further comprising estimating the coherence compensation factor.

Aspect 17: The method of Aspect 16, wherein the coherence compensation factor is estimated in accordance with a phase difference between the first SRS and the second SRS and a phase difference between the first PUSCH communication and the second PUSCH communication.

Aspect 18: The method of any of Aspects 11-17, wherein transmitting the coherence compensation factor includes transmitting the coherence compensation factor via a MAC-CE.

Aspect 19: The method of any of Aspects 11-18, wherein the first PUSCH communication is a first DMRS and the second PUSCH communication is a second DMRS.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit a first sounding reference signal (SRS) via a first antenna;
transmit a second SRS via a second antenna, wherein the first antenna and the second antenna are not coherent;
transmit a first physical uplink shared channel (PUSCH) communication via the first antenna;
transmit a second PUSCH communication via the second antenna; and
receive a coherence compensation factor having a value in accordance with one or more phase differences associated with the first antenna and the second antenna.

2. The UE of claim 1, wherein at least one of the one or more phase differences includes an SRS phase difference between the first SRS and the second SRS.

3. The UE of claim 1, wherein at least one of the one or more phase differences includes a PUSCH phase difference between the first PUSCH communication and the second PUSCH communication.

4. The UE of claim 1, wherein the one or more processors are further configured to cause the UE to:
transmit a third SRS via the first antenna;
transmit a fourth SRS via the second antenna; and
transmit, in accordance with the coherence compensation factor, a third PUSCH communication via the first antenna.

5. The UE of claim 4, wherein the one or more processors are further configured to cause the UE to transmit a fourth PUSCH communication via the second antenna, wherein the fourth PUSCH is transmitted without applying the coherence compensation factor.

6. The UE of claim 1, wherein the one or more processors are further configured to cause the UE to apply the coherence compensation factor to one or more uplink communications transmitted via the first antenna.

7. The UE of claim 6, wherein applying the coherence compensation factor reduces the one or more phase differences to an error margin associated with antenna coherence.

8. The UE of claim 1, wherein the one or more processors, to cause the UE to receive the coherence compensation factor, are configured to cause the UE to receive, from a network node, the coherence compensation factor via a medium access control (MAC) control element.

9. The UE of claim 1, wherein the first antenna is part of a first antenna subgroup and the second antenna is part of a second antenna subgroup, and
wherein the first antenna subgroup lacks coherence relative to the second antenna subgroup.

10. The UE of claim 1, wherein the first PUSCH communication is a first demodulation reference signal (DMRS) and the second PUSCH communication is a second DMRS.

11. A method of wireless communication performed by a user equipment (UE), comprising:
transmitting a first sounding reference signal (SRS) via a first antenna;
transmitting a second SRS via a second antenna, wherein the first antenna and the second antenna are not coherent;
transmitting a first physical uplink shared channel (PUSCH) communication via the first antenna;
transmitting a second PUSCH communication via the second antenna; and
receiving a coherence compensation factor having a value in accordance with one or more phase differences associated with the first antenna and the second antenna.

12. The method of claim 11, wherein at least one of the one or more phase differences includes an SRS phase difference between the first SRS and the second SRS.

13. The method of claim 11, wherein at least one of the one or more phase differences includes a PUSCH phase difference between the first PUSCH communication and the second PUSCH communication.

14. The method of claim 11, further comprising:
transmitting a third SRS via the first antenna;
transmitting a fourth SRS via the second antenna; and
transmitting, in accordance with the coherence compensation factor, a third PUSCH communication via the first antenna.

15. The method of claim 14, further comprising transmitting a fourth PUSCH communication via the second antenna, wherein the fourth PUSCH is transmitted without applying the coherence compensation factor.

16. The method of claim 11, further comprising applying the coherence compensation factor to one or more uplink communications transmitted via the first antenna.

17. The method of claim 11, wherein receiving the coherence compensation factor includes receiving, from a network node, the coherence compensation factor via a medium access control (MAC) control element.

18. The method of claim 11, wherein the first antenna is part of a first antenna subgroup and the second antenna is part of a second antenna subgroup, and
wherein the first antenna subgroup lacks coherence relative to the second antenna subgroup.

19. The method of claim 11, wherein the first PUSCH communication is a first demodulation reference signal (DMRS) and the second PUSCH communication is a second DMRS.

20. An apparatus for wireless communication, comprising:
means for transmitting a first sounding reference signal (SRS) via a first antenna;
means for transmitting a second SRS via a second antenna, wherein the first antenna and the second antenna are not coherent;
means for transmitting a first physical uplink shared channel (PUSCH) communication via the first antenna;
means for transmitting a second PUSCH communication via the second antenna; and
means for receiving a coherence compensation factor having a value in accordance with one or more phase differences associated with the first antenna and the second antenna.
